(19) United States
(12) Patent Application Publication
(10) Pub. No.: US 2026/0239168 A1
(43) Pub. Date: Aug. 13, 2026

(54) METHOD AND SYSTEM FOR RESOURCE MANAGEMENT IN A NETWORKED ECOSYSTEM

(71) Applicant: GM GLOBAL TECHNOLOGY OPERATIONS LLC, Detroit, MI (US)

(72) Inventors: Jinzhu Chen, Troy, MI (US); Venkata Naga Siva Vikas Vemuri, Farmington Hills, MI (US); Azin Neishaboori, Plymouth, MI (US); Fan Bai, Ann Arbor, MI (US); John Sergakis, Bloomfield Hills, MI (US); Ahmed F. Al Alawy, Canton, MI (US); Mustafa H. Chmeiseh, Shelby Township, MI (US)

(73) Assignee: GM GLOBAL TECHNOLOGY OPERATIONS LLC, Detroit, MI (US)

(21) Appl. No.: 19/049,360

(22) Filed: Feb. 10, 2025

(51) Int. Cl. H04W 40/24; H04W 40/22; H04W 84/20

(52) U.S. Cl. CPC H04W 40/24; H04W 40/22; H04W 84/20

(57) ABSTRACT

A resource management system for a networked or Internet-of-Things (IoT) ecosystem is described. The IoT ecosystem has a first initiator node, a second initiator node, a plurality of relay nodes, a first target node, and a second target node. The first target node is out of range of the first initiator node and the second target node is out of range of the second initiator node. The IoT ecosystem employs an extended multi-hop proximity ranging protocol to measure a first range between the first initiator node and the first target node via a first subset of the relay nodes. A master node determines first parameters related to a first range measurement request, and second parameters related to a second range measurement request. The master node prioritizes the first range measurement request in relation to the second range measurement request based upon the first parameters and the second parameters.

### INTRODUCTION

Advancements in global automation technology have led to the adoption of network-based management of a myriad of storage, diagnostic, maintenance, sensors, actuators, control, and other operations. For example, at-home charging operations of modern electric vehicles (EVs) or plug-in hybrid electric vehicles (PHEVs) may be scheduled and managed using “smart garage” network connectivity. Other aspects of smart garage automation include smartphone-based monitoring and opening/closing operation of garage doors, as well as control of climate settings such as temperature, humidity, and air quality. Security systems may be similarly managed from a remote location. Within different environments, such as a garage or a manufacturing plant, such automation also facilitates inventory, tool, and parts management along with a host of other functions. Similar technologies may be applied to other environments, including but not limited to a user's home or office, industrial applications such as a manufacturing facility or an assembly facility, a distribution center, a warehouse, etc.

The effective implementation of global automation solutions relies on accurate proximity ranging between connected devices, i.e., a knowledge of distances between communication nodes. Proximity ranging in the context of global smart garage automation and other exemplary Internet of Things (IoT) applications generally refers to the process of determining a distance between such nodes. Common proximity ranging techniques using electromagnetic waves include estimating a distance between a transmitter and a receiver based on received signal strength, based on the amount of time it takes for a transmitted packet from a transmitter to reach the receiver, i.e., time-of-flight, and other techniques. The transmitted signals may be ultra-wideband (UWB), Bluetooth™ Low Energy (BLE), Wi-Fi, etc. However, such techniques are only capable of measuring a proximity range between two devices within each other's immediate proximity. For some emerging home or industrial IoT use cases demanding low-latency, or those in which not all IoT devices belong to the same network or trust circle, such maximum proximity limits for range measurements may result in a suboptimal user experience.

There may be periods in which multiple initiators within a networked ecosystem coincidently request ranging intent, creating congestion and device conflicts.

### SUMMARY

The present disclosure pertains to resource management in a networked ecosystem, i.e., management of controller (or CPU) time, power, and bandwidth for a proximity ranging protocol. The solutions presented herein—referred to hereinafter as “multi-hop” proximity ranging—are intended to manage, prioritize, and schedule resources such as wireless bandwidth, local CPU and cloud computing resources, etc. based upon factors related to urgency, criticality, task completion times, etc. in an Internet of Things (IoT) environment, e.g., the above-noted global smart garage application, or in industrial applications in which devices located on different wireless networks, including in different buildings or operational areas, are required to determine inter-nodal distance measurement, or ranging therebetween, wherein the determined distance is used to trigger one or more actions. The disclosed proximity ranging resource management protocol may be used to govern end-to-end proximity ranging in the above-noted local networked ecosystem, within which an initiator node requests multiple connected relay nodes to estimate the distance to an out-of-range target node. The disclosed protocol may be implemented to dynamically estimate the distance between the initiator and target node. The dynamic aspect refers to when the initiator node, target node, or one or more of the relay nodes used for multi-hop ranging is moving, or when a subset of the relay nodes leave the network, new relay nodes join the network, or the characteristics of the relay nodes, such as their computational power or energy status change.

An aspect of the disclosure may include a resource management system for a networked or Internet-of-Things (IoT) ecosystem. The IoT ecosystem has a first initiator node, a second initiator node, a plurality of relay nodes, a first target node, and a second target node, wherein the first target node is out of range of the first initiator node and the second target node is out of range of the second initiator node. One of the first initiator node, the second initiator node, the first target node and the second target node is designated a master node. The IoT ecosystem employs an extended multi-hop proximity ranging protocol to measure a first range between the first initiator node and the first target node via a first subset of the plurality of relay nodes. The master node determines a plurality of first parameters related to a first range measurement request, which includes employing the extended multi-hop proximity ranging protocol to determine a first range between the first initiator node and the first target node via the first subset of the plurality of relay nodes. The master node determines a plurality of second parameters related to a second range measurement request, which includes employing the extended multi-hop proximity ranging protocol to determine a second range between the second initiator node and the second target node via the second subset of the plurality of relay nodes. The master node prioritizes the first range measurement request in relation to the second range measurement request based upon the plurality of first parameters and the plurality of second parameters.

Another aspect of the disclosure may include the plurality of first parameters related to employing the extended multi-hop proximity ranging protocol being parameters related to at least one of an urgency and a criticality of the first range measurement request.

Another aspect of the disclosure may include the plurality of second parameters related to employing the extended multi-hop proximity ranging protocol being parameters related to at least one of an urgency and a criticality of the second range measurement request.

Another aspect of the disclosure may include the first subset of the plurality of relay nodes being not mutually exclusive of the second subset of the plurality of relay nodes.

Another aspect of the disclosure may include the plurality of first parameters related to employing the extended multi-hop proximity ranging protocol to measure the range between the first initiator node and the first target node being at least one of a location of the first initiator node and a distance between the first initiator node and one of the first subset of the plurality of relay nodes.

Another aspect of the disclosure may include the plurality of second parameters related to employing the extended multi-hop proximity ranging protocol to measure the range between the second initiator node and the second target node being at least one of a location of the second initiator node and a distance between the second initiator node and one of the second subset of the plurality of relay nodes.

Another aspect of the disclosure may include one of the plurality of relay nodes being anchored to a fixture.

Another aspect of the disclosure may include the at least one target node being a first target node and a second target node; wherein the control node prioritizes the first range measurement request from the first initiator node and the first target node via the first subset of the plurality of relay nodes in relation to the second range measurement request from the second initiator node and the second target node via the second subset of the plurality of relay nodes based upon the plurality of first parameters and the plurality of second parameters.

Another aspect of the disclosure may include the IoT ecosystem further being a centralized system, wherein the centralized system includes a centralized controller that is arranged to execute the extended multi-hop proximity ranging protocol, wherein the centralized controller is in communication with the first initiator node, the second initiator node, the plurality of relay nodes, the first target node, and the second target node.

Another aspect of the disclosure may include the IoT ecosystem being a decentralized system.

Another aspect of the disclosure may include a method for resource management for a networked ecosystem, which includes identifying, in the networked ecosystem, a first initiator node, a second initiator node, a plurality of relay nodes, a first target node, and a second target node, wherein the first target node is out of range of the first initiator node and the second target node is out of range of the second initiator node, wherein one of the first initiator node, the second initiator node, the first target node and the second target node is a master node; determining, via an extended multi-hop proximity ranging protocol, a first range between the first initiator node and the first target node via a first subset of the plurality of relay nodes; determining a plurality of first parameters related to a first range measurement request, which includes determining a first range between the first initiator node and the first target node via the first subset of the plurality of relay nodes; determining, via the master node, a plurality of second parameters related to a second range measurement request, including employing the extended multi-hop proximity ranging protocol to determine a second range between the second initiator node and the second target node via the second subset of the plurality of relay nodes; and prioritizing the first range measurement request in relation to the second range measurement request based upon the plurality of first parameters and the plurality of second parameters.

The above-summarized features and other features and advantages of this disclosure will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a representative networked ecosystem configured to use a centralized extended multi-hop proximity ranging strategy, in accordance with the disclosure.

FIG. 2 is a block diagram illustrating a protocol for implementing the centralized extended multi-hop ranging strategy, in accordance with the disclosure.

FIGS. 3A and 3B illustrate models for performing the centralized extended multi-hop proximity ranging strategy in accordance with the disclosure.

FIG. 4 schematically illustrates a control routine in the form of a flow chart describing a method for implementing the extended multi-hop proximity ranging strategy in accordance with the disclosure.

FIG. 5 schematically illustrates a weighted round-robin control scheme, which may be employed in an embodiment of the networked ecosystem to assign bandwidth to various nodes to effect multi-hop proximity ranging in accordance with the disclosure.

FIG. 6 schematically illustrates elements of a centralized proximity ranging system and associated method to effect extended multi-hop ranging in a networked ecosystem in accordance with the disclosure.

FIG. 7 schematically illustrates elements of a decentralized proximity ranging system and associated method to effect extended multi-hop ranging in a networked ecosystem in accordance with the disclosure.

FIG. 8 schematically illustrates a multi-ecosystem/fabric model for consolidating messages in scenarios in which an initiator node of an IoT network sends messages or reports via different IoT hubs, in accordance with the disclosure.

FIG. 9 schematically illustrates a multi-ecosystem/fabric model for consolidating messages in scenarios in which an initiator node of an IoT network sends messages or reports via a master node, in accordance with the disclosure

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

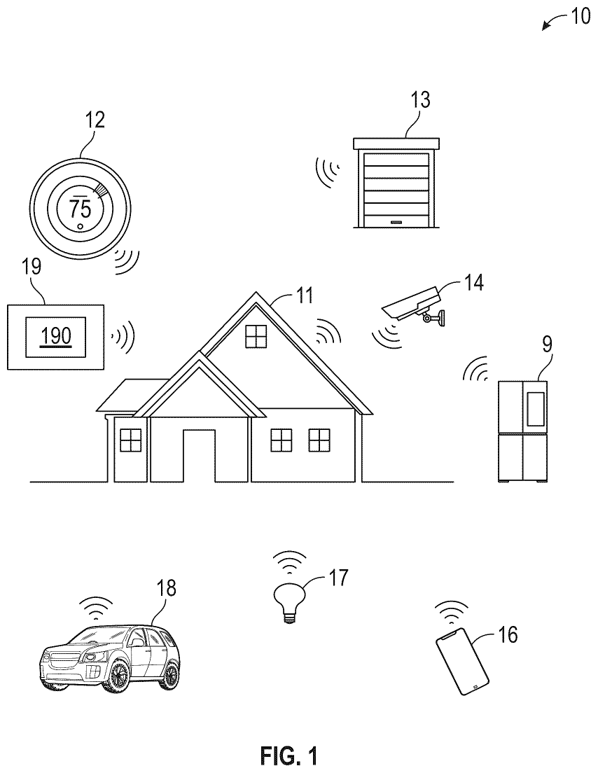

Referring now to the drawings, wherein like reference numbers refer to like features throughout the several views, a local internet-of-things (IoT) networked ecosystem 10 is illustrated in FIG. 1 in which multiple communication nodes are in networked communication with one another as set forth herein. The networked ecosystem 10 shown in FIG. 1 is described as a non-limiting global automated smart garage of a smart home 11, also referred to as an IoT hub 11. In such an embodiment, the above-noted nodes may include one or more of, e.g., a wireless/Wi-Fi-enabled thermostat 12, a garage door 13, a security camera 14, an appliance 9, a smartphone 16 or other smart device, e.g., a smart watch or another wearable, etc., a light bulb 17, a vehicle 18, etc. As will be described below, the networked ecosystem 10 also includes a computer readable storage medium 19 with an activation profile 190 recorded or stored therein, the activation profile being a desired action or service of a target node or device as described below. The activation profile 190 is accessible from the computer readable storage medium 19 as part of the present approach. The actual host or location of the computer readable storage medium 19 is some form of controller, and may vary depending on the embodiment, and thus is depicted as separate from the various networked devices in FIG. 1.

Alternatively, the networked ecosystem may be an automated industrial facility, e.g., a manufacturing plant, assembly plant, fulfillment center, or warehouse, with work areas for performance of various related operations. For example, the networked ecosystem may include an inventory section, e.g., shelves or part/component bins, one or more production lines, a receiving area, and office space among other possible areas or workspaces. In such an embodiment, the above-noted nodes may correspond to varies computers, wireless devices, sensors, smart devices, etc., including passive radio frequency identification (RFID) tags, barcodes/bar code readers, and the like.

Descriptions of the smart home, smart garage implementations, and smart facilities of FIG. 1 is used hereinafter solely for illustrative consistency, with the actual number and construction of the constituent nodes participating in the networked ecosystem 10 varying with the intended application.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to an occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter can have a discrete value, e.g., either “1” or “0”, or can be infinitely variable in value.

In this description and the following claims, the term “cloud” and related terms may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

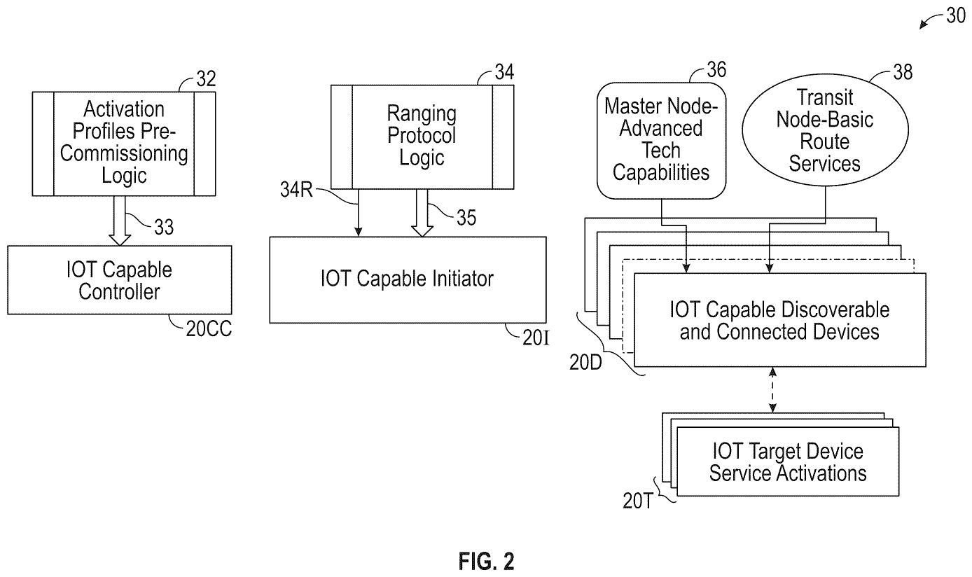

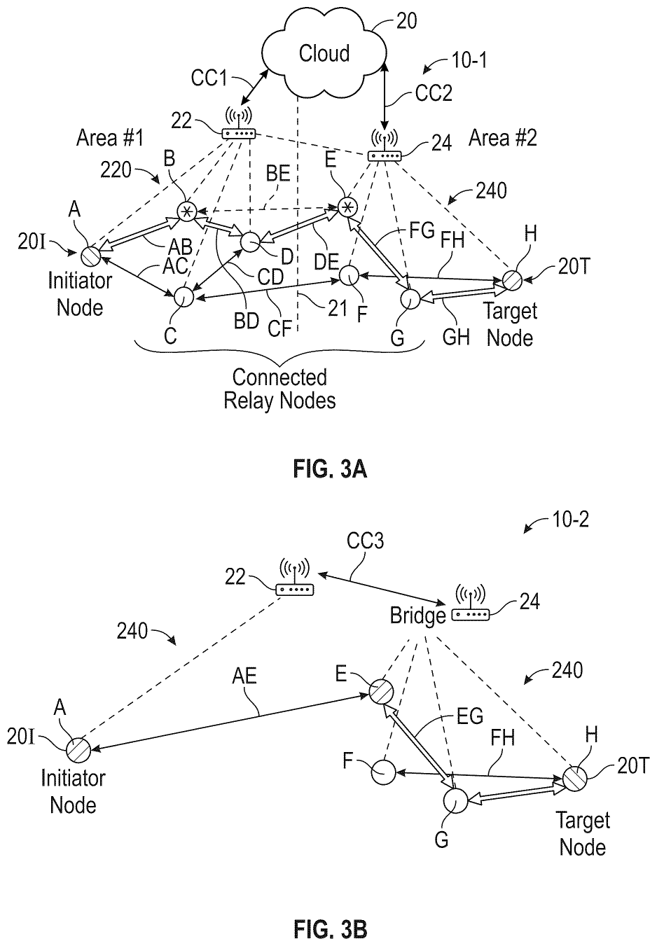

Referring to FIGS. 3A and 3B, both of which are discussed in greater detail below, the networked ecosystem 10 includes an initiator node 201, e.g., including an ultra-wideband (UWB) capability, and a plurality of relay nodes B,C,D E,F,G that are connected, with the relay nodes including at least one lower-capability transit node and at least one higher-capability “smart” node as described in detail below. The networked ecosystem 10 also includes a target node 20T that is located outside of a range limit of the initiator node 201, and thus out of direct communication therewith. The above-noted computer readable storage medium 19 contains the recorded activation profile 190 in this embodiment. The networked ecosystem 10 as set forth herein is also configured to use an extended multi-hop proximity ranging protocol 30 (FIG. 2) to estimate respective ranges to one or more neighboring nodes of the plurality of relay nodes B,C,D E,F,G within a range limit of the initiator node 201, and to dynamically determine an internodal distance between the initiator node 201 and the target node 20T using the respective ranges. One or more of the plurality of relay nodes B,C,D E,F,G is anchored to a fixture.

As contemplated herein, proximity ranging between nodes of the networked ecosystem 10 of FIG. 1, involves accurately estimating inter-nodal distances. For example, a manufacturing, assembly, kitting, or order fulfilment operation may occur across multiple areas or buildings. Multiple buildings within a manufacturing plant will tend to have multiple controllers or routers, which in turn are connected to a centralized controller, e.g., a local controller or a cloud-based controller. Ranging between two devices located in two different buildings may require cloud support. The centralized extended multi-hop ranging approach of the present disclosure may be used in such cases.

As an example, modern proximity ranging techniques for typical smart home/garage, manufacturing plants, and other local network applications are conducted in accordance with the open-source Matter™ (MATTER) standard, which in turn is directed to managing the communication of locally networked devices. In some applications, a device/node may send activation commands to a target node based at least in part on the proximity of the target node. However, users of the networked ecosystem 10 of FIG. 1, an industrial IoT use case, or other home, office, industrial, medical, or other use cases may benefit from reduced latency and the improved customer experience stemming therefrom.

For instance, a user walking from a kitchen to a garage of their smart home 11 (FIG. 1) may, upon reaching the garage, expect to find the garage door 13 already fully open and their vehicle 18 disconnected from a charging station (not shown), and/or conditioned according to custom settings of the user approaching the vehicle 18 where the conditioning may include one or more of seat adjustments, mirror adjustments, cabin temperature settings, and others. The user's overall experience may be degraded somewhat if the user is left waiting for the scheduled actions to be completed before entering the vehicle 18. The extended multi-hop proximity ranging protocol 30 is therefore directed toward extending communication distances and reducing response latency, preventing out-of-range activation errors, and improving the overall customer experience within a local network such as the representative networked ecosystem 10 of FIG. 1.

Although omitted for illustrative simplicity from the various Figures, the hardware associated with the various nodes of FIG. 1 may be in the form of one or more Application Specific Integrated Circuit(s) (ASIC), Field-Programmable Gate Array (FPGA), electronic circuit(s), central processing unit(s), e.g., microprocessor(s) or processors, and associated computer readable storage medium/memory. Non-transitory components of such memory, including the computer readable storage medium 19 of FIG. 1, are capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Using such hardware and associated antenna, receivers, and transmitters residing at the various nodes, therefore, information may be exchanged wirelessly between nodes, e.g., via Wi-Fi, Zigbee, Bluetooth™, Bluetooth™ Low-Energy (BLE), etc.

Referring to FIG. 2, the extended multi-hop proximity ranging protocol 30 may be used in the centralized and decentralized alternative embodiments described below with reference to FIGS. 3A and 3B, respectively. The extended multi-hop proximity ranging protocol 30 is illustrated as a block diagram for illustrative clarity. In an IoT context, actions are triggered at a target node based on predetermined or prerecorded user profiles. For example, a user of the networked ecosystem 10 of FIG. 1 walking from a kitchen to a garage of the illustrated smart home 11 may, upon reaching the garage, expect the temperature setting, and/or seats and mirrors of vehicle 18 to be adjusted according to their custom levels. Similarly, a user walking around the smart home 11 may set profiles for when to turn on the light bulb 17, charge or stop charging the vehicle 18, etc., relative to the user's position in the smart home 11. Similar expectations may be present in an industrial embodiment for other networked devices.

Although such profiles are already set, the extended multi-hop proximity ranging strategy disclosed herein allows extension of the distance between the initiating and target nodes relative to existing strategies, as noted above. This extended range may result in a better user experience, particularly since some actions such as opening/closing doors, disengaging electric vehicle (EV) charging handlers, or custom adjustments within a vehicle in preparation for a specific driver take time to complete after initiation, and thus, earlier activation of them enabled by the enhanced proximity ranging, helps reduce or eliminate the time the user has to wait for their completion. Programmed actions are thus able to commence sooner than they otherwise would be without benefit of the present teachings.

In FIG. 2, block 32 represents such activation profiles, which may be communicated to an IoT-capable controller 20CC as indicated by arrow 33. Such a controller 20CC may be variously embodied as a master/“smart” node in a centralized ecosystem model 10-1 as shown in FIG. 3A or 10-2 (FIG. 3B) as described below. The extended multi-hop proximity ranging protocol 30 also include a proximity ranging block 34, which as represented by arrow 35 is deployed on or hosted by an initiator node 201, e.g., the vehicle 18 of FIG. 1, the smartphone 16, etc. The proximity ranging block 34 may provide the activation rules 34R needed for operating in accordance with the disclosure.

Also included in the extended multi-hop proximity ranging protocol 30 of FIG. 2 are various relay nodes including IoT capable/discoverable connected relay devices B,C,D E,F,G within the networked ecosystem 10 operating as either lower-capability transit nodes or higher-capability smart nodes. Transit nodes include, e.g., RFID tags and other low-power IoT devices that may go to sleep. Smart nodes include devices having multiple antennas that are capable of determining time-of-arrival (ToA) and/or angle-of-arrival (AoA). Block 36 represents such advanced technological capabilities such as lower power limitations, higher computational capabilities, angle-of-arrival (AoA) estimation capability, or others, for the smart nodes, while block 38 represents the lower capabilities of transit nodes, e.g., RFID tags and possibly other low-power IoT devices typically in a sleep mode, thus requiring time to wake up and take actions such as proximity ranging. The extended multi-hop proximity ranging protocol 30 also considers operation of the target node 20T, i.e., the intended performer of actions initiated via service activations from the initiator node 201. The examples that follow rely on the architecture of the extended multi-hop proximity ranging protocol 30 of FIG. 2.

FIG. 3A schematically illustrates elements of a networked ecosystem 10-1 that execute an embodiment of the extended multi-hop proximity ranging protocol 30 employing a centralized system. The centralized ecosystem model 10-1 illustrates various devices/nodes that are nominally labeled A-H for simplicity. FIG. 3A is an exemplary implementation in which a central controller, in this case a cloud-based or other central controller, is leveraged to reach an out-of-range target node 20T for activation thereon of a desired action or service. Such leveraging may be performed using cloud-based or external edge networks. While the present teachings are sufficiently flexible to conduct centralized multi-hop ranging with or without network separation, FIG. 3A illustrates a representative case in which two areas (Area #1 and Area #2) are separated from each other by a border 21, for instance walls between different structures, designated workspaces, buildings, or other areas. The present teachings may be used for ranging session resource management and communication in this or other densely deployed network environments.

In FIG. 3A, node A represents an initiator node 201, i.e., a node/device that initiates a request to communicate with and request a desired action or service of a target node 20T (node H) located out-of-range of the initiator node. Nodes B, C, D, E, F, and G represent relay nodes, which may be configured as the above-described transit nodes and none, one, or more of which may be configured as more computationally capable smart nodes. The centralized ecosystem model 10-1 of FIG. 3A also includes additional network nodes, in this case a cloud-based controller 20, a wireless router 22, e.g., a Wi-Fi, Thread®, MATTER, or Zigbee router, and a border router 24, likewise a Wi-Fi, Thread®, MATTER, or Zigbee border router. Nodes B and E in this embodiment act as so-called “anchor” nodes (described below), with this anchor status denoted in FIG. 3A by an asterisk (*). In general, if a device operating in Area #1 uses the wireless router 22 in the form of a Zigbee network router to activate a device in Area #2, e.g., operating a MATTER network via the border router 24, the device ranges/localizes with a given designated node in the MATTER network, in this case node E(*). The designated node E would then reach the target node 20T via one or more relay nodes within the MATTER network, e.g., node G.

In a home charging application in which the smart home 11 (FIG. 1) is connected to electric vehicle supply equipment (EVSE) in the form of an electric charger, the charger may act as a designated node, with a user approaching the smart home 11 ranging through the designated node. Thus, the use of designated nodes may be used to enhance security. Thus, identifying a ranging path between the initiator node 201 and the target node 20T herein, e.g., via the central controller 20, may entail using a ranging path that includes the designated node. This action in turn may include estimating, via the central controller 20 using the proximity ranging protocol of FIG. 2, respective proximity ranges to one or more neighboring nodes of the plurality of relay nodes within a range limit of the initiator node 201. Respective nodes of the one or more neighboring nodes in this exemplary case are in the initiator network or the target network. Upon estimating the range(s) to the neighboring node(s), each neighboring node may be instructed to estimate the range between itself and the target node 20T.

In FIG. 3A, the present approach may assume the initiator node 201 is already part of the exemplary MATTER network. This assumption may be expanded on. The initiator node 201 or target node 20T may in some instances undergo a commissioning process to join the MATTER network but may still use the above-noted designated node as a proxy to initiate/be part of a new multi-hop proximity ranging session. For instance, the vehicle 18 (FIG. 1) may not be part of the MATTER network but still use an electric vehicle supply equipment (EVSE) charging station (e.g., part of an original equipment manufacturer (OEM) network or the exemplary MATTER network) as a proxy to invoke action on another device, such as a television set or a lighting system, as the commissioning process continues.

In the illustrated deployment space, each node is capable of at least two functions: (i) communication, and (ii) ranging. The ranging function can include performing time-of-arrival (ToA) measurement and angle-of-arrival (AoA) measurement. Functionalities (i) and (ii) may be from the same wireless technology, e.g., Wi-Fi, or from different wireless technologies such as Wi-Fi and ultra-wideband (UWB). Additionally, each node connects to the central controller 20 (a local or cloud-based server or back end) through respective wireless communication networks, e.g., Wi-Fi, THREAD, Zigbee, etc., with corresponding gateways. The initiator node 201 can be part of an initiator network, while the target node 20T can be part of a target network which may be, for instance, a proprietary network. In embodiments where the network of the initiator node and target node are different, the initiator node 201 communicates with the target node 20T via the intervening central controller 20 in the various embodiments. As shown by dotted lines BE and CF in FIG. 3A, the present multi-hop approach has the flexibility to enable or disable internetwork ranging/localization. In some implementations the central controller 20 determines the ranging path(s) from one node to another, and in particular from the initiator node 201 to the target node 20T.

As appreciated in the art, the border router 24 of FIG. 3A may be used to connect a local network to the internet via the wireless router 22, or to a wider network or networks. As its name implies, the border router 24 may be located at an edge of a network, in this case the initiator network/first wireless network that is served by the wireless router 22. Functionally, the border router 24 is used to route data traffic and thus act as a gateway between a local network and one or more external networks. The wireless router 22 is used to communicate with nodes within a given local network, e.g., nodes A, B, C, and D in the non-limiting simplified embodiment of FIG. 3A, as represented by link lines 220. The wireless router 22 may also be connected to the internet, for instance via an ethernet box (not shown) that the wireless router 22 is connected to, connection to a fiber or coax cable, a cellular link, or others. The border router 24 connects other nodes, nominally nodes E, F, G, and H, to the wireless router 22 via the central controller 20 as indicated by arrows CC1 and CC2. within FIG. 3A, link lines 220 and 240 represent wireless communication pathways within the networked ecosystem 10.

In the centralized extended multi-hop method and system disclosed herein, the following assumptions are made: (1) some of the nodes are equipped with antenna arrays, and are capable or measuring AoA and TOA, such as ultra-wideband (UWB)-capable nodes, e.g., the smartphone 16 or other mobile device, or the vehicle 18 of FIG. 1, a moving automation robot, etc., and (2) each AoA/ToA capable node is connected to the cloud-based controller 20, e.g., an external central server capable of communicating ranging parameters between an initiating network in Area #1 and a target network of Area #2 of FIG. 3, through various wireless networks as shown. The cloud-based controller 20 is also referred to herein as a central controller 20

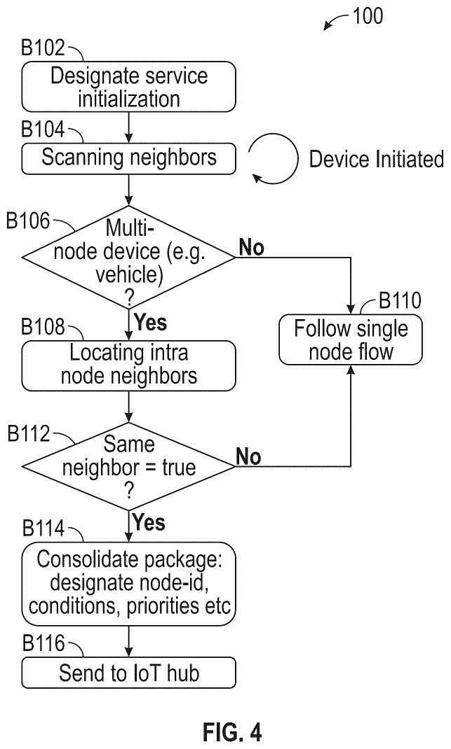

Features of the centralized multi-hop strategy of FIG. 3A include local distance map creation, centralized multi-hop localization, and dynamic neighbor sampling. For local distance map creation, each AoA-capable node periodically scans neighboring nodes, the periodicity of the scan being determined by the mobility of the network or a determination of the capabilities of the neighboring nodes. An embodiment according to the current disclosure includes communicating from a local network in Area #1 to the cloud-based controller 20, and ultimately to the target node 20T via the central controller 20. An embodiment entails using another route when links BE and DF do not exist, in which case the initiator network may localize within its area, i.e., Area #1, and communicate through the central controller 20 to infer locations of nodes located in Area #2. A method according to an embodiment for implementing centralized extended multi-hop localization is described below with reference to FIG. 4. Regarding dynamic neighbor sampling, a shortest distance or path algorithm may be used to find the path, with scanning periodicity increased on ranging path nodes. Thus, in embodiments according to the current disclosure, the proximity ranging method described herein may include using a shortest distance algorithm to determine a nodal path from the initiator node 201 to the target node 20T through the one or more neighboring nodes, or determine a path based on nodes with higher power and/or computational capabilities. For example, plugged-in nodes may be more suitable than battery-operated nodes. Nodes with higher state of charge may be more suitable than those with lower state of charge. Higher computationally capable nodes may be more suitable than lower ones.

Referring briefly to FIG. 3B, a centralized ecosystem model 10-2 according to another embodiment of the disclosure. Functions of the central controller 20 of FIG. 3A may be performed using other nodes. A bridge CC3 exists between the wireless routers 22 and 24, e.g., a wireless point-to-point network connection. In a possible use case, a mobile device employed as the initiator node 201 in an original equipment manufacturer (OEM)-specific network may attempt to activate a device in an IoT network such as a MATTER network. The mobile device, e.g., the smartphone 16 of FIG. 1, may communicate with a designated node in the IoT network/OEM network in this event such that the mobile device reaches the target node 20T solely via relay nodes of the IoT network, e.g., nodes E, F, and G in the simplified network example of FIG. 3B, including the designated node. The designated node may be configured with authentication, security, and/or privileges to interact with the initiator node 201 or the target node 20T. The initiator node 201 and/or the target node 20T in one or more embodiments is also not capable of directly interacting (or not allowed to directly interact) with any other node on a network of which the target node 20T is a member.

Referring to FIG. 4, an embodiment of a method 100 is described to illustrate an aspect of the present teachings. In general, the method 100 is directed to managing intranodal interactions in a networked IoT environment, with such a networked environment embodied herein as the IoT environment 10 of FIG. 1. The method 100 may include using a service-requesting, possibly high power initiator node of the networked ecosystem 10, or the IoT hub 11, to identify a candidate smart device among a plurality of neighboring nodes. The candidate smart device may be high power, low power, or hybrid (flexibly operable as a low power device type or a high power device type) based on requirements of the initiator node. The method 100 includes selectively assigning the candidate device as a trusted designated node within the networked ecosystem 10 based on a battery level or other parameter of the initiator node. The method 100 also includes determining, based on a parameter of the initiator node, an optimal periodicity of communication of status messages from the initiator node to an IoT hub 11 of the networked ecosystem 10. The method 100 includes using the trusted designated node for transmitting the status messages to the IoT hub 11 with the optimal periodicity. This action occurs via the designated node such that the trusted designated node negotiates periodicity and acts as a proxy for the initiator node when reporting the status messages to the IoT hub 11.

A representative embodiment of the method 100 as shown in FIG. 4 begins at logic block B102. Here, the method 100 includes initializing or requesting a service via an initiator node. The method 100 then proceeds to block B104.

Block B104 entails scanning neighboring nodes 15 for candidate nodes, i.e., one or more nodes 15 that could possibly serve as the above-described trusted designated node. This may include scanning for neighboring devices/nodes within its proximity range that could possibly serve as the trusted designated node. The method 100 then proceeds to block B106.

At block B106, the method 100 includes determining if the initiator node is a multi-node device. The method 100 proceeds to block B108 when the initiator node is a multi-node device, and to block B110 in the alternative when the initiator node is a single-node device.

Block B108 is arrived at from block B106 after a determination that the initiator node is a multi-node device. Block B108 includes locating intranode neighbors. As appreciated in the art, an intranode neighbor in the networked ecosystem 10 is a neighboring device/node connected or belonging to the same local network segment as the scanning device. For instance, intranode neighbors may share a router or network connector in common. The method 100 proceeds to block B112 after locating intranode neighbors.

At block B110, the method 100 of FIG. 4 proceeds to follow a single-node flow, for instance as described above with reference to FIG. 1. The method 100 is then complete, with the single trusted designated node thereafter functioning as a proxy for messaging by the initiator node.

Block B112 includes determining if intranode neighbors are located at block B108. The method 100 proceeds to block B114 when an intranode neighbor is located. The method 100 proceeds in the alternative to block B110 when an intranode neighbor is not located.

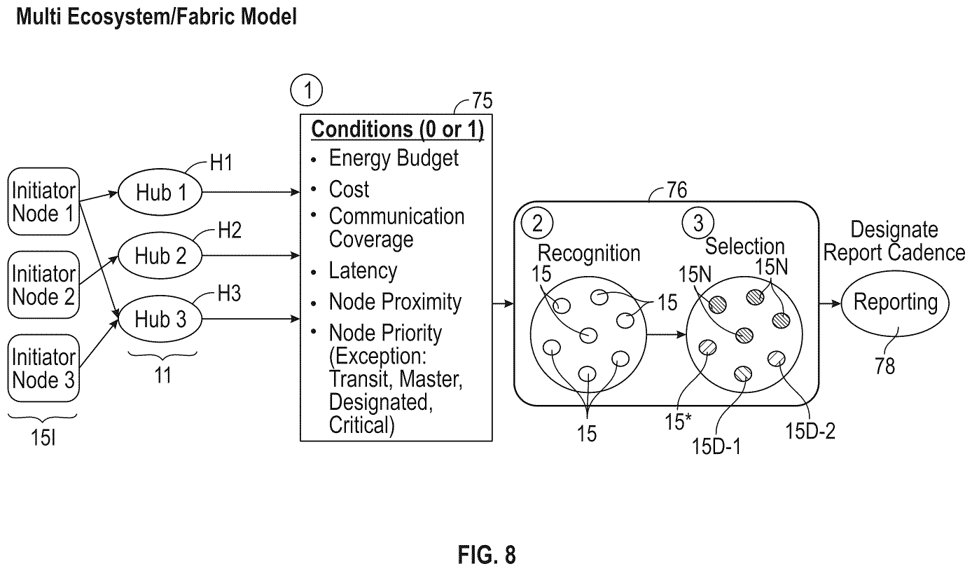

Block B114 includes consolidating a message package as described above with reference to FIG. 8. The method 100 thereafter proceeds to block B116.

At block B116, the consolidated message is sent to the IoT hub 11, e.g., the IoT hub H1 or H3 of FIG. 8. The method 100 is then complete.

As set forth above, the present solutions are directed to methods and nodal systems for introducing a smart device as a designated node into a networked IoT ecosystem such as the networked ecosystem 10 of FIG. 1. The designated node, based on a parameter such as an energy budget of an initiator device would then selectively negotiate an optimal engagement periodicity for message exchange with an IoT hub 11. Reporting by the trusted designated node may be based on the parameter or current situation of the requesting device.

The trusted designated node may be classified as such and selected in some instances by an initiator node/device. In other approaches, the IoT hub 11 may assist in the selection of the trusted designated node. Reporting is then performed at an energy budget-appropriate cadence or periodicity. This action ensures that a high power device types is usable as part of the IoT ecosystem 10, e.g., a Matter ecosystem, even when in a power-depleted state. This is ensured by using the trusted designated node as a proxy for device status reporting to the IoT hub 11. This in turn would help minimize power drain of a battery in such an embodiment. These and other attendant benefits will be readily appreciated by those possessing ordinary skill in the art in view of the foregoing disclosure.

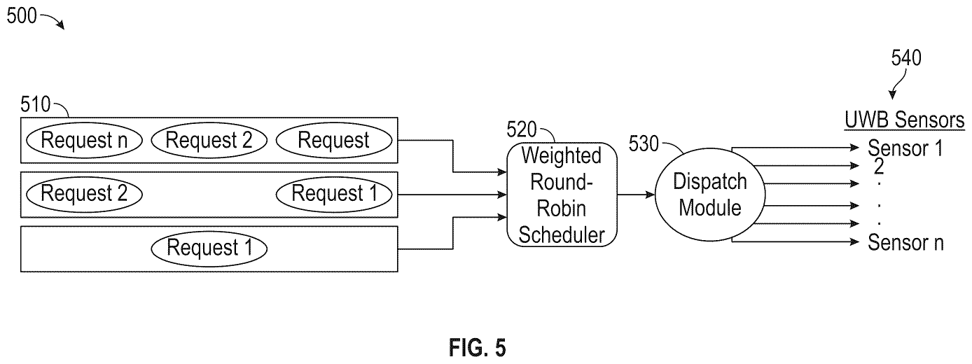

FIG. 5 schematically illustrates a weighted round-robin control scheme 500, which may be employed in an embodiment of the networked ecosystem 10 (FIG. 1) to assign bandwidth to various nodes to effect multi-hop proximity ranging between a plurality of initiator nodes 510 and a plurality of receiver nodes 540 based upon message criticality, urgency, and task complexity.

A plurality of initiator nodes 510 generates communication requests (Request 1, Request 2, Request n), which are sent to a round-robin scheduler 520. The round robin scheduler 520 executes a weighted round-robin algorithm that assigns ranging resources, including time and bandwidth allocated to exchange one or more packets to measure range and/or AoA, computational resources to compute range and/or AoA based on receiving the one or more packets, to the plurality of initiator nodes 510. The ranging requests from the plurality of initiator nodes 510 are dispatched via a dispatch module 530 to the plurality of receiver nodes 540 in accordance with the assigned ranging resources.

Operation of the round-robin scheduler 520 includes as follows. Each Initiator has its own weight, Wi, which is determined employing a utility function U based on its application as well as if it is actively used as multi-hop node for ranging/localization, as follows:

$$W i = U ( Ci / ( Di * Ti ) ) ,$$

wherein:
   Ci represents criticality (Ci),
   Di represents a deadline or urgency, and
   Ti represents task completion complexity

Each task has an average length Li from the initiator node.

A long term bandwidth is determined for each of the plurality of initiator nodes 510, as follows:

$$Li * Wi / {\sum }_{i = 1}^{N} Li * Wi = Li * Ui ( Ci , Di , Ti )$$

This arrangement is implemented to avoid starving weaker initiator nodes and reasonable proportional distribution of communication bandwidth between the initiator nodes.

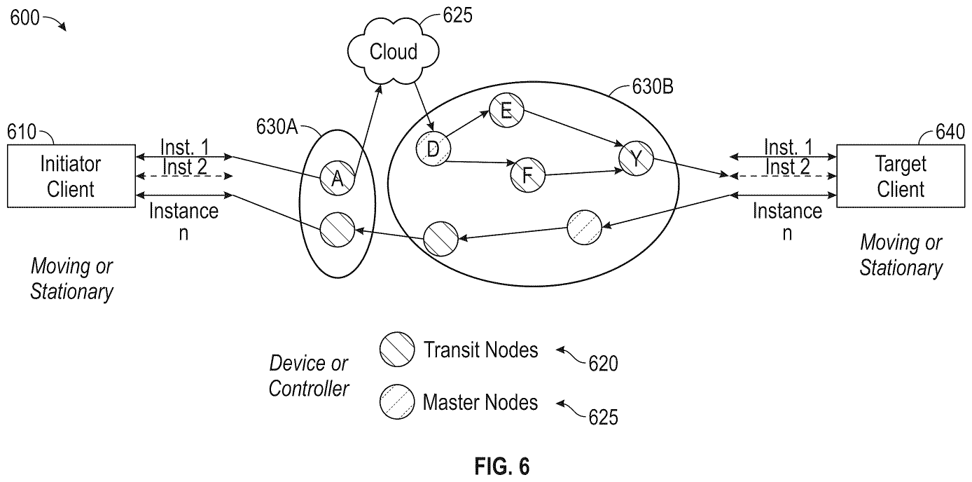

FIG. 6 schematically illustrates a elements of a centralized proximity ranging system 600 and associated method to effect extended multi-hop ranging, which may be employed in an embodiment of the networked ecosystem 10 described with reference to FIG. 1. The centralized proximity ranging system 600 includes a first set of connected relay nodes 630A and a second set of connected relay nodes 630B, with operation and connectivity being managed by a central controller 625, wherein the central controller 625 is cloud-based in one embodiment. The first set of connected relay nodes 630A and the second set of connected relay nodes 630B may be composed with smart nodes (Master Nodes) and/or transit nodes. The central controller 625 includes algorithmic code that is capable of executing the extended multi-hop proximity ranging protocol 30 that is described with reference to FIG. 2.

A moving or stationary initiator node (“Initiator Client”) 610 initiates one or multiple communication efforts (“Inst. 1, Inst 2, Instance n”) to effect communication within the centralized proximity ranging system 600 with a target node (“Target Client”) 640, which may also be moving or stationary. In one embodiment, the target node 640 is out of range of the initiator node 610, precluding direct communication therewith. The central controller 625 evaluates and manages communication and inter-node proximity estimation across the first set of connected relay nodes 630A and the second set of connected relay nodes 630B employing the extended multi-hop proximity ranging protocol 30, taking into account conditions that include an energy budget, energy consumption, communication coverage, latency, node proximity, and node priority, e.g., transit, designated, critical, etc., node priority.

Operation of the centralized proximity ranging system 600 includes as follows. When there are multiple initiator nodes, e.g., a first initiator node and a second initiator node, seeking to simultaneously perform multi-hop range estimation with one or multiple target nodes within the centralized proximity ranging system 600, the first control node, i.e., central controller 625, determines a plurality of first parameters related to employing the extended multi-hop proximity ranging protocol 30 to request a range measurement between the first initiator node and the at least one target node via a first subset of the plurality of relay nodes, and also determines a plurality of second parameters related to employing the extended multi-hop proximity ranging protocol to request a range measurement between the second initiator node and the at least one target node via the second subset of the plurality of relay nodes. The first and second parameters include parameters related to node status, message characteristics such as urgency, criticality, task completion complexity/times, sleep mode; a location of the initiator node, distance of the initiator node to one of the relay nodes, etc. The control node prioritizes a first communication request from the first initiator node and the at least one target node via the first subset of the plurality of relay nodes in relation to a second communication request from the second initiator node and the at least one target node via the second subset of the plurality of relay nodes based upon the plurality of first parameters and the plurality of second parameters.

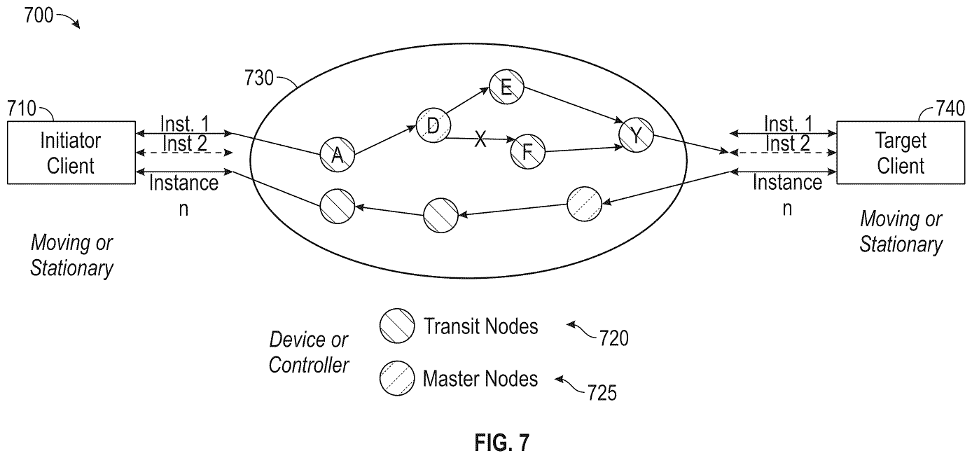

FIG. 7 schematically illustrates elements of a decentralized proximity ranging system 700 and associated method to effect extended multi-hop ranging, which may be employed in an embodiment of the networked ecosystem 10 described with reference to FIG. 1. The decentralized proximity ranging system 700 includes a plurality of connected relay nodes 720 including transit nodes 730, and one or more master node(s) 725, with operation and connectivity being managed by the master node(s) 725 based on information locally available to the master node(s). The master node(s) 725 includes algorithmic code that can execute the extended multi-hop proximity ranging protocol 30 that is described with reference to FIG. 2.

A moving or stationary initiator node (“Initiator Client”) 710 initiates one or multiple ranging efforts (Inst. 1, Inst 2, Instance n) to effect ranging within the networked ecosystem 10 with a target node (“Target Client”) 740, which may also be moving or stationary. The master node(s) 725 evaluates and manages communication and proximity to the neighboring relay nodes in their one-hop proximity range employing the extended multi-hop proximity ranging protocol 30, taking into account conditions that include an energy budget, energy consumption, communication coverage, latency, node proximity, and node priority, e.g., transit, designated, critical, etc., node priority. In this embodiment, each of the relay nodes chooses the next relay node on the path to the target node based on the set of metrics.

Referring now to FIG. 8, in some cases a device in the networked IoT ecosystem 10 may include multiple IoT hubs 11, e.g., hubs H1, H2, and H3. In the representative embodiment of FIG. 1, hubs H1, H2, and H3 may be embodied as multiple different control modules of the vehicle 18. A device with such connectivity options may require smart and consolidated optimization capabilities for assigning one of the nodes as a trusted designated node and for determining an energy-appropriate reporting cadence or periodicity. Various nodes 15 may serve as the initiator node 151. A device acting as node N1 may request a range measurement with hubs H1 and H3, while a device acting as node N2 may request a range measurement with hub H2. Similarly, a device acting as node N3 may request a range measurement with hub H3. In this example, therefore, node N1 has two possible communication options, i.e., hub H1 or hub H3.

In a situation in which one device uses multiple hubs, the act of sending periodic reports consumes significant processing power, requires coordination of sleep/wake cycles, and the like. To reduce power consumption, an aspect of the present strategy consolidates reports and determines an optimum time to send the reports/messages to one of the IoT hubs 11. Representative conditions are illustrated in condition table 75 as, e.g., energy budget, energy consumption, communication coverage, latency, node proximity, and node priority, e.g., transit, designated, critical, etc. Based on these conditions, a population of candidate nodes 15 is recognized, from which a preferred node is selected. In some embodiments, the various conditions may be normalized and weighted, such that collectively the condition table 75 outputs a binary decision (0 or 1) as to whether to assign a trusted designated node or continue to use the initiator node 151 to communicate its status messages to the IoT hub 11.

In block 76, for instance, the nodes 15 are evaluated against the condition table 75 to determine trusted designated nodes, shown as 15D-1 and 15D-2 for simplicity. Nodes 15N are disregarded as lacking the required capabilities in view of the conditions. Node 15* may be a possible designated node, but based on conditions and relative capabilities, the designated nodes 15D-1 and 15D-2 are deemed to be preferred choices. Of the two remaining designated nodes 15D-1 and 15D-2, node 15D-2 may be presently occupied, i.e., engaged in performing functions that preclude its use as a trusted designated node. This would leave node 15D-1 as available to serve and capable of serving as the trusted designated node 15D. Node 15D-1 in this example is then assigned as the trusted designated node, followed by reporting (block 78).

In one embodiment, a centralized approach envisions use of a central controller, e.g., a cloud-based server, backend device, or local server, that is operable to request a range measurement with the target node for the above-noted service activation. Without cloud or on-site communication between different buildings, for example, range-based applications are usually not implementable in a multi-building scenario. In instances in which nodes/devices that require ranging do not collectively reside on one communication network, the present concept may seek a relay node or nodes using the central controller and thereby orchestrate extended multi-hop ranging in accordance with the disclosure.

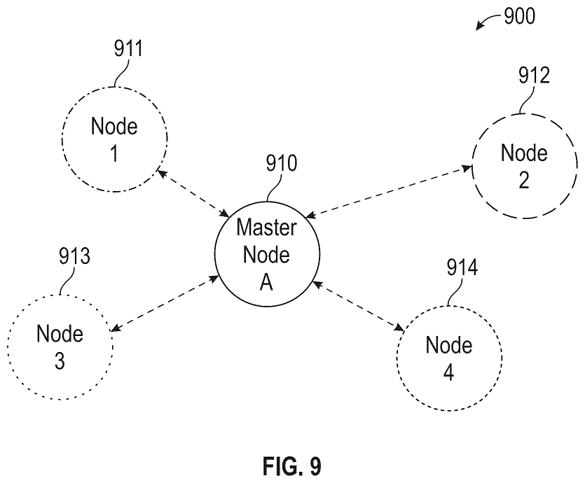

FIG. 9 schematically illustrates a distributed multi-ecosystem 900 or fabric model according to embodiments of the current disclosure where a master node is used to perform multi-hop ranging between two other IoT nodes within the multi-ecosystem so as to perform an action upon determining the range. The multi-ecosystem 900 includes Master Node A 910, Node 1 911, Node 2 912, Node 3 913, and Node 4 914. In this embodiment the Master Node A 910 listens to and records information included in periodical announcements from other IoT nodes in its communication range, for example, Node 1 911, Node 2 912, Node 3 913, and Node 4 914. Each message includes one or more of: the address of the reporting node (IP, MAC, and/or other device identifiers), and the identity and capabilities of the node, the indication that whether the node is within the proximity range of the Master Node A 910, which may help the Master Node A 910 select a relay node which is on the way to a given target node when it receives a multi-hop ranging request, and a list of other IoT nodes in the one-hop proximity range of the reporting IoT node, which may further help the Master Node A 910 create a local map of the layout of other IoT devices in its vicinity and that can be used at least in part to select a relay node which is on the way to a given target node when it receives a multi-hop ranging request from an initiator node. Other information associated with the plurality of nodes, e.g., Node 1 911, Node 2 912, Node 3 913, and Node 4 914, include capabilities of the respective IoT node such as power source (battery operated or plugged in), indication of SOC of the respective node, awake time schedule of the respective node, capability and willingness to participate in range measurement, capability and willingness to participate in an Angle of Arrival measurement, computational capacity, mobility of the respective node, e.g., movable or stationary node, location information of the respective node (including timestamp if movable device), available transmit power used to send the periodical update, and maximum transmit power. The available transmit power used to send the periodical update may assist the Master Node 910 in determining which nodes in its communication range is also in its proximity range and thus can be useable for multi-hop ranging. The maximum transmit power may be used to determine a radius of the reporting node for inter-node range measurement. While low-capability IoT nodes might not be able to share some of this information, other master nodes in communication range of Master Node A 910 can share more information and therefore help it better map out the layout of the nodes around and thereby making more efficient node selection when a multi-hop ranging request is received. The Master Node A 910 may periodically rank nodes in its proximity range based on the recorded information and use this information when e.g., (a) determining to serve a multi-hop ranging request or not, (b) determine the best next hop relay node for a request it accepted, (c) schedule its resources when serving more than one multi-hop ranging request.

The concepts described herein provide a system and method for multi-hop ranging resource management wherein multiple initiator devices request multi-hop ranging from a node having management capability, wherein the node prioritizes and schedules resources based on a status of a set of candidate relay nodes for multi-hop ranging. Prioritization may also be based on characteristics of each of the requests including one or more of criticality and urgency, and sleep mode schedule.

Prioritization may also be based on characteristics including one or more of the location of the requesting node, the distance of the node to one or more relay nodes, and the sleep mode schedule of the requesting node.

Prioritization may also be based on a ranging capability with certainty above a predetermined threshold between pairs of candidate relay nodes, and the processing resources available to the centralized node.

Prioritization may also include periodically establishing ranks for candidate relay nodes, and wherein the rank of a candidate relay node is determined based on one or more of power resources, ranging technology, the rate it measures its proximity with its neighbor nodes, computing resources, knowledge of its own location, and/or whether it is a mobile or static node.

In one embodiment, a centralized node performs multi-hop ranging via more than one multi-hop route, and combines the results of the acquired ranges to improve accuracy.

In one embodiment, a centralized node schedules resources for more than one multi-hop ranging requests so as to optimize a utility function, wherein the utility function is based on one or more of criticality, urgency, request deadline, task completion time, and/or total energy consumption.

In one embodiment, the first node prioritizes and schedules multi-hop ranging resources to the requests based on one or more of the criticality of the request, the urgency of the request, and the energy needed at the first node to complete the request.

In one embodiment, prioritization is further based on the ranging capability with certainty above a predetermined threshold between the initiator node and a candidate relay node, and/or between two candidate relay nodes, and the processing resources available to each relay node.

In one embodiment, a candidate relay node within proximity of the initiator node that has an angle of arrival measurement capability is preferred to a candidate relay node which does not have that capability.

In one embodiment, a candidate relay node having plugged-in power source is preferred to a battery-operated candidate relay node.

In one embodiment, a static candidate relay node is preferred to a mobile candidate relay node.

In one embodiment, the multi-hop ranging identifies more than one relay node, and wherein the range between the initiator node and target node is determined iteratively.

In one embodiment, the extended multi-hop proximity ranging protocol includes computing an angle between the line connecting two nodes not in immediate range of each other and a reference direction, and wherein the distance between the two nodes is measured via a relay node capable of computing range and angle of arrival between itself and each of the two nodes. This may include iteratively determining the range between the initiator and target node by identifying a route that includes the initiator node, the target node, and a set of two or more relay nodes in a specific order, and wherein the range and angle to a reference direction between the initiator and target node is determined by iteratively computing the range and angle to a reference direction between a first node and a second node on the route, the first and second nodes not in immediate proximity range of each other, the iteration further comprising subsequently selecting another node on the route according to the specific order to replace the second node.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

1. A resource management system for an Internet-of-Things (IoT) ecosystem, comprising:
an IoT ecosystem having a first initiator node, a second initiator node, a plurality of relay nodes, a first target node, and a second target node, wherein the first target node is out of range of the first initiator node and the second target node is out of range of the second initiator node;
wherein one of the first initiator node, the second initiator node, the first target node and the second target node is designated a master node;
wherein the IoT ecosystem employs an extended multi-hop proximity ranging protocol to measure a first range between the first initiator node and the first target node via a first subset of the plurality of relay nodes;
wherein the IoT ecosystem employs the extended multi-hop proximity ranging protocol to measure a second range between the second initiator node and the second target node via a second subset of the plurality of relay nodes;
wherein the master node determines a plurality of first parameters related to a first range measurement request, wherein the first range measurement request includes employing the extended multi-hop proximity ranging protocol to determine the first range between the first initiator node and the first target node via the first subset of the plurality of relay nodes;
wherein the master node determines a plurality of second parameters related to a second range measurement request, wherein the second range measurement request includes employing the extended multi-hop proximity ranging protocol to determine a second range between the second initiator node and the second target node via a second subset of the plurality of relay nodes; and
wherein the master node prioritizes the first range measurement request in relation to the second range measurement request based upon the plurality of first parameters and the plurality of second parameters.

2. The resource management system of claim 1, wherein the plurality of first parameters related to employing the extended multi-hop proximity ranging protocol comprises parameters related to at least one of an urgency and a criticality of the first range measurement request.

3. The resource management system of claim 1, wherein the plurality of second parameters related to employing the extended multi-hop proximity ranging protocol comprises parameters related to at least one of an urgency and a criticality of the second range measurement request.

4. The resource management system of claim 1, wherein the first subset of the plurality of relay nodes is not mutually exclusive of the second subset of the plurality of relay nodes.

5. The resource management system of claim 1, wherein the plurality of first parameters related to employing the extended multi-hop proximity ranging protocol to measure the range between the first initiator node and the first target node comprises at least one of a location of the first initiator node and a distance between the first initiator node and one of the first subset of the plurality of relay nodes.

6. The resource management system of claim 1, wherein the plurality of second parameters related to employing the extended multi-hop proximity ranging protocol to measure the range between the second initiator node and the second target node comprises at least one of a location of the second initiator node and a distance between the second initiator node and one of the second subset of the plurality of relay nodes.

7. The resource management system of claim 1, wherein one of the plurality of relay nodes is anchored to a fixture.

8. The resource management system of claim 1, wherein the master node prioritizes the first range measurement request from the first initiator node and the first target node via the first subset of the plurality of relay nodes in relation to the second range measurement request from the second initiator node and the second target node via the second subset of the plurality of relay nodes based upon the plurality of first parameters and the plurality of second parameters.

9. The resource management system of claim 1, wherein the IoT ecosystem further comprises a centralized system, wherein the centralized system includes a centralized controller that is arranged to execute the extended multi-hop proximity ranging protocol, wherein the centralized controller is in communication with the first initiator node, the second initiator node, the plurality of relay nodes, the first target node, and the second target node.

10. The resource management system of claim 1, wherein the IoT ecosystem comprises a decentralized system.

11. A method for resource management for a networked ecosystem, the method comprising:
identifying, in the networked ecosystem, a first initiator node, a second initiator node, a plurality of relay nodes, a first target node, and a second target node, wherein the first target node is out of range of the first initiator node and the second target node is out of range of the second initiator node, wherein one of the first initiator node, the second initiator node, the first target node and the second target node is a master node;
determining, via an extended multi-hop proximity ranging protocol, a first range between the first initiator node and the first target node via a first subset of the plurality of relay nodes;
determining, via the extended multi-hop proximity ranging protocol, a second range between the second initiator node and the second target node via a second subset of the plurality of relay nodes;
determining, via the master node, a plurality of first parameters related to a first range measurement request, which includes determining the first range measurement between the first initiator node and the first target node via the first subset of the plurality of relay nodes;
determining, via the master node, a plurality of second parameters related to a second range measurement request, which includes determining the second range between the second initiator node and the second target node via the second subset of the plurality of relay nodes; and
prioritizing the first range measurement request in relation to the second range measurement request based upon the plurality of first parameters and the plurality of second parameters.

12. The method of claim 11, wherein determining the plurality of first parameters related to the first range measurement request comprises determining parameters related to at least one of an urgency and a criticality of the first range measurement request.

13. The method of claim 11, wherein determining the plurality of second parameters related to the second range measurement request comprises determining parameters related to at least one of an urgency and a criticality of the second range measurement request.

14. The method of claim 11, wherein the first subset of the plurality of relay nodes is not mutually exclusive of the second subset of the plurality of relay nodes.

15. The method of claim 11, wherein determining the plurality of first parameters related to the first range measurement request comprises determining at least one of a location of the first initiator node and a distance between the first initiator node and one of the first subset of the plurality of relay nodes.

16. The method of claim 11, wherein determining the plurality of second parameters related to the second range measurement request comprises determining at least one of a location of the second initiator node and a distance between the second initiator node and one of the second subset of the plurality of relay nodes.

17. A resource management system for a networked ecosystem, comprising:
the networked ecosystem having a control node, a first initiator node, a second initiator node, a plurality of relay nodes, a first target node, and a second target node, and a master node, wherein one of the first target or the second target node is out of range;
wherein the networked ecosystem employs an extended multi-hop proximity ranging protocol to effect range measurement between the first initiator node and the first target node via the plurality of relay nodes, and employs the extended multi-hop proximity ranging protocol to effect range measurement between the second initiator node and the second target node via the plurality of relay nodes;
wherein the master node determines a plurality of first parameters related to a first range measurement request, which includes employing the extended multi-hop proximity ranging protocol to determine a first range between the first initiator node and the first target node via a first subset of the plurality of relay nodes;
wherein the master node determines a plurality of second parameters related to a second range measurement request, which includes employing the extended multi-hop proximity ranging protocol to determine a second range between the second initiator node and the second target node via a second subset of the plurality of relay nodes; and
wherein the master node prioritizes the first range measurement request in relation to the second range measurement request based upon the plurality of first parameters and the plurality of second parameters.

18. The resource management system of claim 17, wherein the master node comprises one of the plurality of relay nodes.

19. The resource management system of claim 17, wherein each of the relay nodes selects a next relay node on a path to the target node based on a localized set of metrics associated with the relay node.

20. The resource management system of claim 17, wherein determining the plurality of first parameters related to the first range measurement request comprises determining at least one of a location of the first initiator node and a distance between the first initiator node and one of the first subset of the plurality of relay nodes, and wherein determining the plurality of second parameters related to the second range measurement request comprises determining at least one of a location of the second initiator node and a distance between the second initiator node and one of the second subset of the plurality of relay nodes.
